(19) United States
(12) Patent Application Publication
(10) Pub. No.: US 2007/0175313 A1
(43) Pub. Date: Aug. 2, 2007

(54) MP3 player holder assembly

(76) Inventor: Kevin Vandervliet, Oxnard, CA (US)

Correspondence Address: EDWIN TARVER, 16830 Ventura Blvd., SUITE 360, Encino, CA, 91436, US

(21) Appl. No.: 11/343,249

(22) Filed: Jan. 31, 2006

(51) Int. Cl. G10D 7/12

(52) U.S. Cl. 84/379

(57) ABSTRACT

A holder assembly for attachment to a hand-held microphone; wherein an electronic device such as an MP3 player or iPod is secured to the holder assembly, which includes a horizontal member and a vertical plate-like member. An attachment means along with a plurality of straps with hook and loop fasteners are used to secure the MP3 player on the vertical plate-like member. The horizontal member is made to abut the microphone and a plurality of straps with hook and loop fasteners are used to secure holder assembly to the microphone. A user holding the microphone can then view the lyrics of a song that are displayed on the MP3 player. A Fresnel lens may also be included in the holder assembly to magnify the lyrics. In another embodiment, the microphone body includes a groove for receiving the MP3 player and the vertical plate-like member attached adjacent to the groove.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to holders that are used along with microphones, and more particularly, to a holder assembly that can be removably attached to a microphone. The holder assembly is used to hold an iPod or a similar electronic device.

Attachment devices for microphones have been developed in the past for various purposes. Accordingly, different designs, structures, and attachment mechanisms are adopted for these devices. Some of these devices can attach a microphone to musical instruments such as a guitar, drums, or the like. These types of devices can help in serving the purpose of amplifying the sound from the musical instruments without the need of any adjustable stand, which can be inconvenient at times. While some other devices can be attached to a microphone to conveniently perform related operations such as remotely operating a karaoke machine.

Several attachment devices for a microphone have been developed in art. For example, U.S. Pub. No. 20030001054 to Sargent discloses a mounting device that releasably mounts an accessory, such as a microphone, to a lug of a musical instrument such as a drum. The device includes a base, a lug-engaging connector mounted on the base, and an accessory support mounted on the base. The primary purpose of this device is to amplify the sound, which is different from the present invention.

U.S. Pat. No. 3,665,490 to Oskar discloses a microphone holding device for attachment to guitars or similar plucked-string instruments. The device mainly includes a lightweight clamp, which can be mounted on a guitar body at suitable location. The clamp is provided with holding means for holding one or more microphones. The holding means include one or more protruding studs, which can be externally threaded to accommodate an internally threaded end of a conventional U-shaped microphone holding bracket. However, even in this case, the purpose of the device is to amplify the sound along with increasing the mobility of a performer. Moreover, the structural features of the devices in the Sargent and Oskar applications are substantially different from the present invention.

U.S. Pat. No. 5,633,942 to Terng discloses a microphone mounting structure for a computer keyboard to pick up a user's voice. The structure mainly comprises a keyboard having defining a horizontal bottom chamber, a plurality of equally spaced vertical locating grooves inside the horizontal bottom chamber, a slide carrier slidably mounted in the horizontal bottom chamber, a supporting block, and a microphone holder. A microphone is mounted in a plughole of the microphone holder. However, the construction of this mounting structure along with its purpose is different from the present invention.

In U.S. Pat. No. 5,598,162 to Terashima a holder for a remote controller of a karaoke machine is disclosed. The holder causes the remote controller to be removably held to a handle of a microphone. The holder comprises a portion of an elastic material, which can tightly fit an outer surface of the handle of the microphone. Further, the holder comprises an approximately C-shaped portion, which matches an outer shape of the handle of the microphone. The remote controller comprises infrared-ray-emitting diodes for emitting a signal in response to a user operating the control buttons to the karaoke machine. Although this holder can be removably secured to a hand-held microphone, the structural features of this device, namely, the elastic and C-shaped features are substantially different from the present invention.

Many compact electronic devices with music-downloadable features have been developed. Some of these devices display lyrics of a song while it is being played. Performers can download a song and sing along by looking at the lyrics that are displayed on a screen of the device. This eliminates the need to memorize the lyrics or carry a sheet with lyrics. Generally a performer uses a hand-held microphone for singing, and therefore, holding both the microphone and the lyrics displaying device may be inconvenient.

Therefore, it is an object of the present invention to provide an improved holder assembly for attachment to a microphone, which can be used to secure a lyrics displaying electronic device.

A further object is to provide an improved holder assembly for attachment to a microphone, which is compact and easy to install.

Finally, it is an object of the present invention to provide an improved holder assembly for attachment to a microphone, which can be used in a variety of situations where a microphone is available. These and other objects of the present invention will become better understood with reference to the appended Summary, Description, and Claims.

### SUMMARY

The present invention is an improved holder assembly, which can be secured to a hand-held microphone. An electronic device with music-downloadable and lyrics displaying features such as an MP3 Player, preferably an iPod, can be secured to the holder assembly. The assembly mainly includes a horizontal member and a vertical plate-like member. The vertical plate-like member is of rectangular cross-section and includes two slots along its side edges. The vertical plate-like member is attached to a distal end of the horizontal member. The vertical plate-like member also includes a plurality of suction cups, which are attached between the slots.

The MP3 player is positioned between the two slots of the vertical plate-like member. Following which, the MP3 player is pressed onto the suction cups. A plurality of straps with hook and loop fasteners are then passed over the MP3 player and into the slots to secure the MP3 player to the vertical plate-like member. The horizontal member is made to abut the microphone and a plurality of straps with hook and loop fasteners are used to secure the holder assembly to the microphone. A user holding the microphone can then view the lyrics of a song that are displayed on the MP3 player.

### BRIEF DESCRIPTION OF THE FIGURES

FIG. 1 is a perspective view of the holder assembly in accordance with the present invention.

FIG. 2 is a perspective view of the holder assembly installed on a microphone.

FIGS. 3A and 3B are perspective views of an MP3 player secured to the holder assembly using suction cups.

FIGS. 3C and 3D are perspective views of an MP3 player secured to the holder assembly using suction cups and a strap with hook and loop fasteners.

FIG. 4 is a perspective view of the holder assembly with a Fresnel lens.

FIG. 5 is a perspective view of the MP3 player secured to the holder assembly with the Fresnel lens.

FIG. 6 illustrates perspective views of a microphone body that is designed to anchor the MP3 player.

### FIGURES—REFERENCE NUMERALS

10 . . . Holder Assembly
11 . . . Hand-held Microphone
12 . . . Electronic Device (MP3 Player)
13 . . . Horizontal Member
14 . . . Vertical Plate-like Member
15 . . . Slot in the Plate-like Member
16 . . . Suction Cup
17 . . . Strap with Hook and Loop Fastener
18 . . . Screen of the Electronic Device (MP3 Player)
19 . . . L-shaped Member
20 . . . Fernel Lens
21 . . . Microphone Body according to a second preferred embodiment
22 . . . Groove

### DETAILED DESCRIPTION

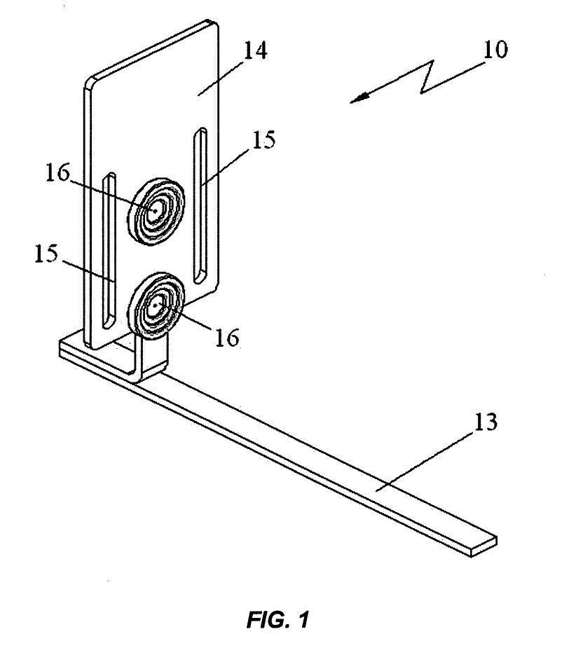

Referring to the drawings, the preferred embodiment of an improved holder assembly 10 for attachment to a hand-held microphone 11 is illustrated in FIGS. 1 through 6. The holder assembly 10 includes suitable means to secure an electronic device with music-downloadable and lyrics displaying features such as an MP3 player 12. The holder assembly is a single piece and can be fabricated by using plastic molding techniques.

Referring to FIG. 1, the holder assembly 10 mainly includes a horizontal member 13 and a vertical plate-like member 14. The plate-like member 14 is of rectangular cross-section and includes two slots 15, one on each side, located near the side edges. The plate-like member 14 is attached near a distal end of the horizontal member 13 that will be farther from a user. Two suction cups 16 are attached to the vertical member 14 to secure the MP3 player 12. In addition to the suction cups, a plurality of straps with hook and loop fasteners can further be used to secure the MP3 player 12 on the vertical member 14. This additional attachment means by using straps increases safety and also helps in firmly securing the MP3 player on the plate-like member.

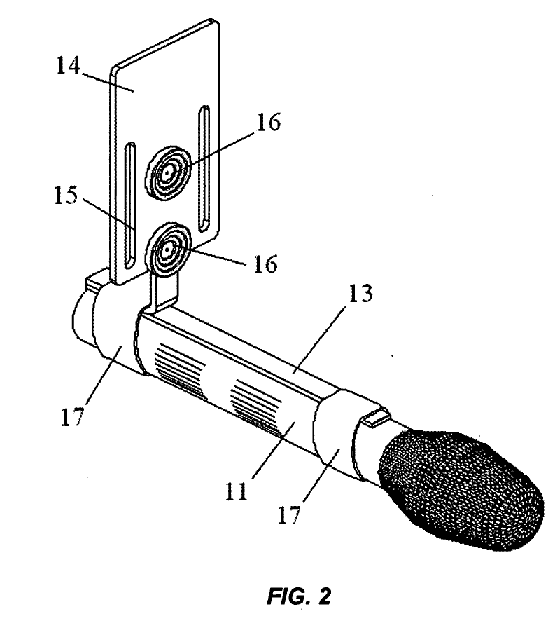

Referring to FIG. 2, two straps with hook and loop fasteners 17 are used as the means to secure the holder assembly 10 to the microphone 11. The horizontal member 13 is made to abut the body of the microphone 11, and the straps 17 are then wrapped around the horizontal member 13 and the body of the microphone 11 to secure the holder assembly 10. Alternately, a plurality of straps with buckles or the like can also be used instead of the straps with hook and loop fasteners 17.

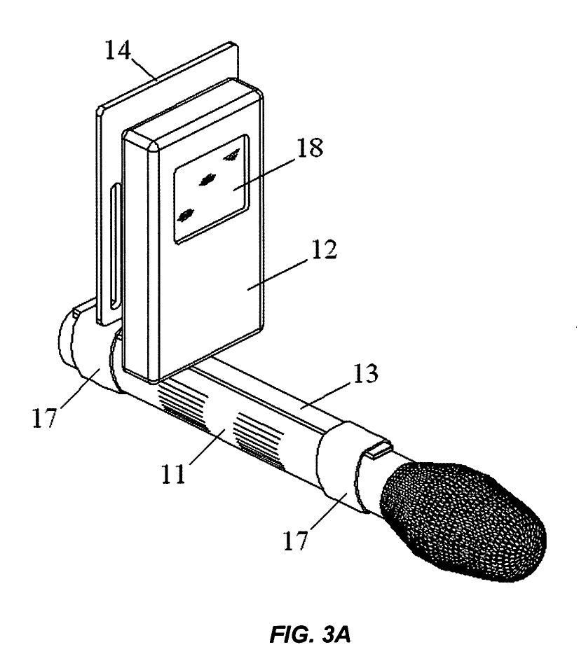

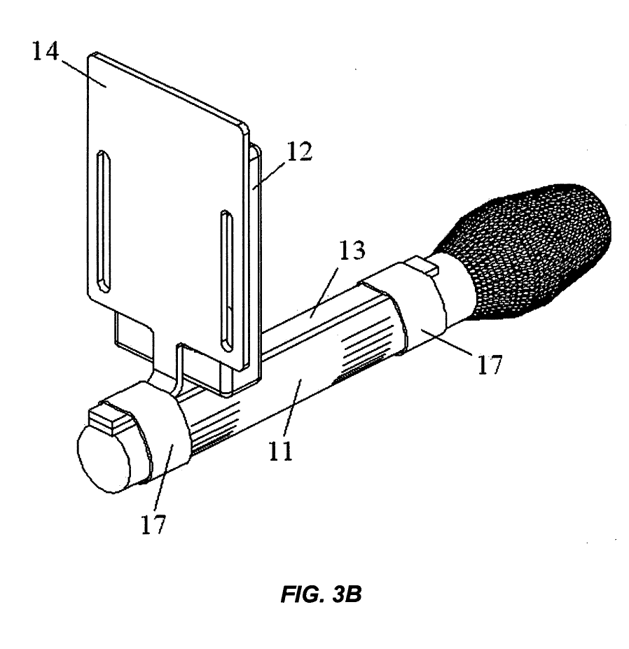

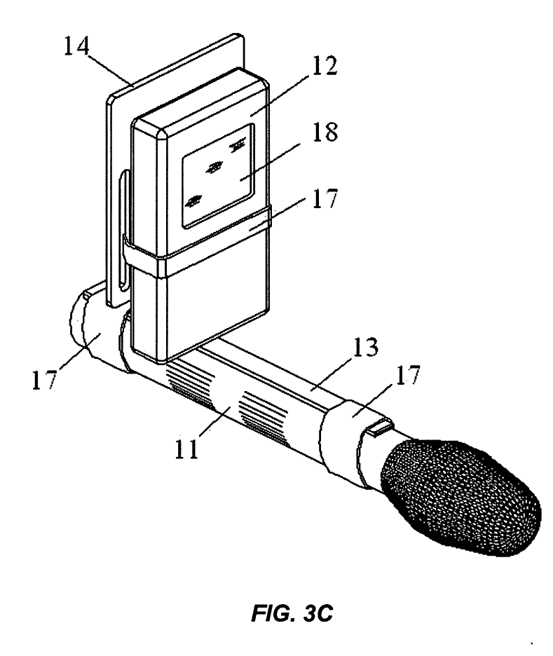

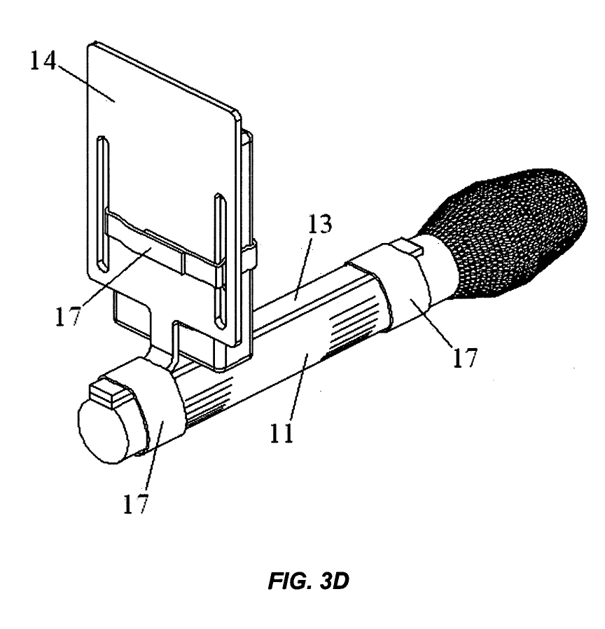

Referring to FIGS. 3A through 3D, the back surface of the MP3 player 12 is positioned between the two slots 15 of the plate-like member 14. Following which, the MP3 player 12 is pressed against the suctions cups 16. A strap with hook and loop fasteners 17 is then passed around the MP3 player 12 and through the slots 15. The straps 17 are then adjusted to firmly secure the MP3 player 12. Finally, after the holder assembly 10 is secured to the microphone 11 and the MP3 player 12 is secured to the plate-like member 14, the user holding the microphone 11 can view the lyrics of a song that are displayed on a screen 18 of the MP3 player 12. The user can download and play any song of his/her interest and can sing along with it by viewing the lyrics displayed on the screen 18.

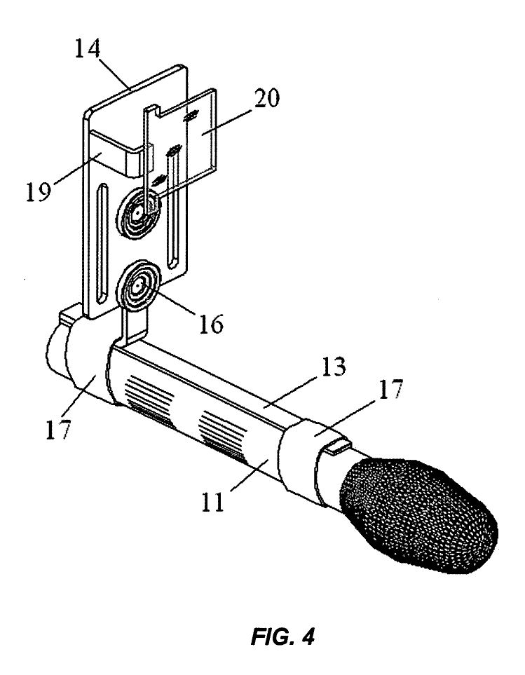

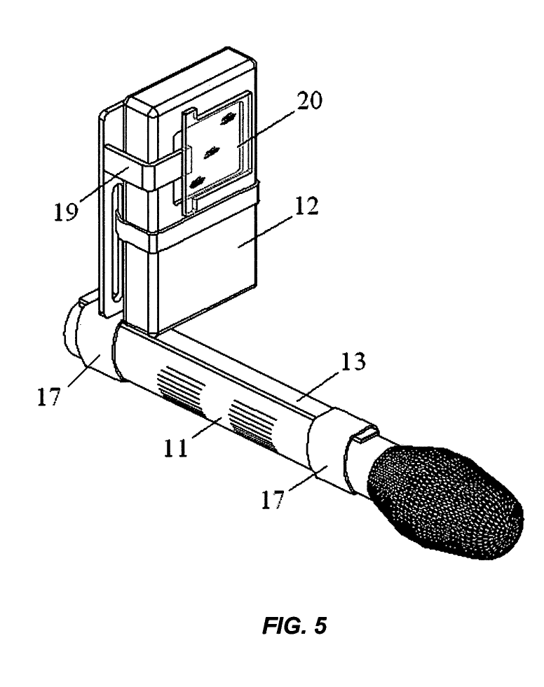

Referring to FIGS. 4 and 5, in an alternate embodiment, the plate-like member 14 includes a L-shaped member 19. The L-shaped member 19 extends perpendicularly from the top left side of the plate-like member 14. A Fresnel lens 20 is attached to a free end of the L-shaped member 19 to magnify the lyrics displayed on the screen 18 of the MP3 player 12. The L-shaped member 19 can be positioned at other suitable locations such as at the top right side of the plate-like member 14.

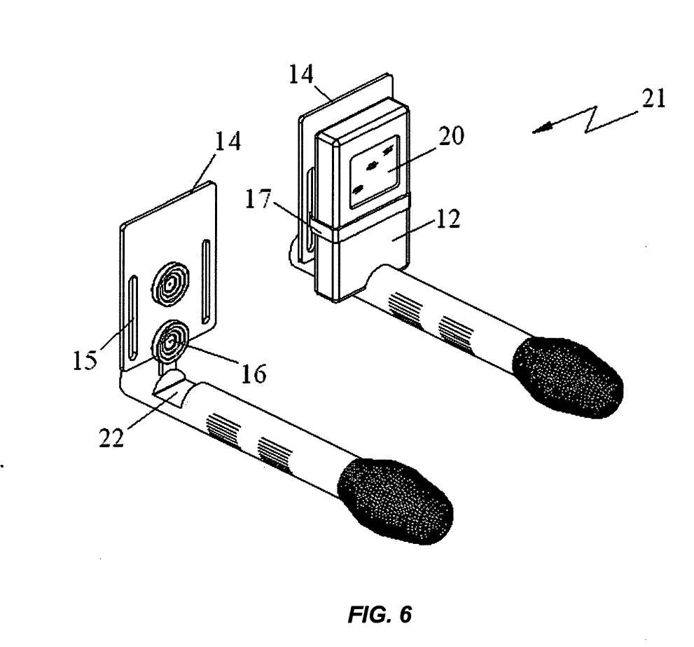

Referring to FIG. 6, in a second embodiment, the microphone body 21 itself could incorporate a design to secure an MP3 player 12. The bottom portion of the microphone body 21 can include a groove 22, which can be designed with suitable clearances to receive a standard sized MP3 player 12. The plate-like member 14, similar to that of previous embodiment, is attached adjacent to the groove 22 of the microphone body 21. The MP3 player 12 is placed in the groove 22 and is positioned between the two slots 15 of the plate-like member 14. At this position, the back surface of the MP3 player 12 abuts the suction cups 16. The MP3 player 12 is then pressed against the suctions cups 16. A strap with hook and loop fasteners 17 is passed around the MP3 player 12 and through the slots 15 to finally secure the MP3 player 12 to the microphone body 21. Even this embodiment may include the L-shaped member 19 for the Fresnel lens 20 attachment.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved holder assembly for attachment to a hand-held microphone, said holder assembly comprising:
an elongate horizontal member;
a vertical plate-like member attached to the elongate horizontal member, the plate-like member including a plurality of slots or holes;
a means to secure an electronic device with lyrics displaying feature such as an MP3 player or ipod on the plate-like member after the electronic device is made to abut the plate-like member;
a means to secure the holder assembly to the microphone after the horizontal member is made to abut said microphone;
wherein a user holding the microphone can view the lyrics of a song that are displayed on the electronic device.

2. The improved holder assembly of claim 1, wherein the horizontal member and the vertical plate-like member are integrated, the vertical plate-like member being attached near a distal end of the horizontal member that is farther from the user.

3. The improved holder assembly of claim 1, wherein a plurality of suction cups along with a plurality of straps with hook and loop fasteners, buckles, or the like are used as the means to secure the electronic device with lyrics
displaying feature on the vertical plate-like member.

4. The improved holder assembly of claim 3, wherein the plurality of suction cups are attached to the vertical plate-like member and the slots or holes are located near the edges of the vertical plate-like member, the electronic device is pressed on the plurality of suction cups and the plurality of straps with hook and loop fasteners are made to pass around the electronic device and through the slots or holes to secure the electronic device on the vertical plate-like member.

5. The improved holder assembly of claim 4, wherein the vertical plate-like member is of rectangular cross-section and the slots or holes are located near its side edges, the plurality of suction cups are attached between the slots or holes.

6. The improved holder assembly of claim 5, wherein the electronic device is pressed on the plurality of suction cups, and a strap with hook and loop fasteners is made to pass around the electronic device and through the slots or holes to secure the electronic device on the vertical plate-like member.

7. The improved holder assembly of claim 1, wherein a plurality of straps with hook and loop fasteners, buckles, or the like can be used as the means to secure the holder assembly to the microphone.

8. The improved holder assembly of claim 1, wherein a Fresnel lens can be attached to the vertical plate-like member at a suitable location for magnifying the lyrics displayed on the electronic device.

9. The improved holder assembly of claim 8, wherein a L-shaped member extends perpendicularly from the vertical plate-like member and towards the user, the Fresnel lens is attached to a free end of the L-shaped member.

10. The improved holder assembly of claim 9, wherein the L-shaped member extends from the top left or top right side of the vertical plate-like member.

11. An improved hand-held microphone for holding an electronic device such as an MP3 player or iPod with lyrics displaying feature, the microphone comprising:
a groove at its bottom portion, the groove designed to receive the electronic device with lyrics displaying feature;
a vertical plate-like member attached to the microphone body, the plate-like member is adjacent to the groove and includes a plurality of slots or holes;
means to removably secure the electronic device on the plate-like member after the electronic device is received in the groove and is made to abut the plate-like member;
whereby a user holding the microphone can view the lyrics of a song that are displayed on the electronic device.

12. The improved hand-held microphone of claim 11, wherein a plurality of suction cups along with a plurality of straps with hook and loop fasteners, buckles, or the like are used as the means to secure the electronic device with lyrics displaying feature on the vertical plate-like member.

13. The improved hand-held microphone of claim 12, wherein the plurality of suction cups are attached to the vertical plate-like member and the slots or holes are located near the edges of the vertical plate-like member, the electronic device is pressed on the plurality of suction cups and the plurality of straps with hook and loop fasteners are made to pass around the electronic device and through the slots or holes to secure the electronic device on the vertical plate-like member.

14. The improved hand-held microphone of claim 13, wherein the vertical plate-like member is of rectangular cross-section and the slots or holes are located near its side edges, the plurality of suction cups are attached between the slots or holes.

15. The improved hand-held microphone of claim 14, wherein the electronic device is pressed on the plurality of suction cups, and a strap with hook and loop fasteners is made to pass around the electronic device and through the slots or holes to secure the electronic device on the vertical plate-like member.

16. The improved hand-held microphone of claim 11, wherein a Fresnel lens can be attached to the vertical plate-like member at a suitable location for magnifying the lyrics displayed on the electronic device.

17. The improved hand-held microphone of claim 16, wherein a L-shaped member extends perpendicularly from the vertical plate-like member and towards the user, the Fresnel lens is attached to a free end of the L-shaped member.

18. The improved hand-held microphone of claim 17, wherein the L-shaped member extends from the top left or top right side of the vertical plate-like member.
